(19) United States
(12) Patent Application Publication
(10) Pub. No.: US 2011/0214750 A1
(43) Pub. Date: Sep. 8, 2011

(54) Fluid Conduit Safety System

(76) Inventor: Andrew Charles Abrams, Bryn Mawr, PA (US)

(21) Appl. No.: 12/716,356

(22) Filed: Mar. 3, 2010

(51) Int. Cl. F16K 17/14

(52) U.S. Cl. 137/68.15

(57) ABSTRACT

In an embodiment, there is disclosed a flexible fluid conduit having a breakaway coupling at one or both ends and a safety system that includes a spring in compression which applies thrust (a pull) to flapper valves at both ends of the flexible fluid conduit through relatively stiff bendable spring rods which push the valves open as long as the flexible hose is intact. Upon a hose failure such as a drive away, a coupling separation, a hose separation, or a longitudinal tear, the spring looses its compression and the pull applied to the valves by the spring in compression changes to a pull which immediately pulls the valves to close.

### BACKGROUND OF THE INVENTION

1. Field of the invention

The present invention relates generally to a flexible fluid conduit for transferring a fluid under a high pressure and more particularly to the connection of a flexible fluid conduit having a safety system in combination with a three bolt breakaway coupling where, in the event of a pull of sufficient force in any direction, at least two of the shear bolts in the coupling will separate.

2. Description of Related Art

When filling containers with compressed or non-compressed gasses or liquids, or operating equipment that relies on pressurized liquid flow or compressed gas, it is necessary for the liquid or gas, hereinafter referred to a fluid, to be transferred from one container to another. Although the fluid can be transferred from one container to another using solid piping, it is common in many situations to use a flexible fluid conduit or hose when connecting one container to another. A flexible fluid conduit allows a user to have a flexible connection/disconnection between the containers, as well as a limited range of motion between the source and destination.

For example, compressed or non-compresses fluids, such as oxygen, nitrogen, carbon dioxide, chemicals, petroleum , petroleum products and acids are transported, stored and used in containers of varying size. To fill these containers with the desired product, it is necessary to connect each container to a filling connection at the location of a gas filler/seller. In order to connect each container to the filling connection, a flexible fluid conduit is used which allows for quick connection/disconnection of the container to the filling connection. A filling station manifold is one example of a filling connection. Under certain condition flexible fluid conduits, which are normally made of durable and flexible materials, can fail.

A common type of a flexible fluid conduit failure can be either a coupling separation that occurs when an operator of a tank truck drives away while the flexible hose that is attached to the tank truck is also attached to an existing tank, or the breakaway coupling does not break away and the hose is stretched and develops a failure.

A prior art couplings in use today consists of two rectangular plates where each plate has a central opening connected to a conduit with a leak proof seal and four shear bolts. When assembled, the two rectangular plates are positioned opposite each other with four clearance openings and the central openings aligned with each other. A leak proof seal such as an 0 ring is located in an annular groove around the central opening and shear bolts are placed into each of the four clearance openings. A nut is placed on each bolt and each nut is tightened until each bolt is stressed to the same predetermined force.

A drive away hose failure can be a rupturing of the hose or a partial coupling separation where less than all of the shear bolts break and the plates are held together by the remaining shear bolts.

When a hose fails, it can result in substantial risk of personal injury, as well as property damage. Still further, a hose failure can result in a leak from both the delivery and receiving ends, leading to a costly waste of fluid, the discharge of a hazardous fluid, as well as introducing hazardous fumes into the environment.

U.S. Pat. No. 5,357,998 discloses a fluid conduit safety system that uses a relatively stiff flexible cable inside a hose to maintain a valve body at each end of the hose in an open condition during normal or open operation. When a failure condition, such as a rupture, cut, separation or stretch of the hose occurs, the valves are closed, sealing both ends of the hose. This prevents fluid leaks from both sources, i.e., container and filling apparatus. When a failure of the hose occurs, the stiff flexible cable may be severed, allowing the fluid pressure to force the valve bodies into engagement with the valve seats. If a hose failure does not sever the cable, the valve seats are either forced into engagement with the valve bodies or the valve bodies are forced into engagement with the valve seats. In either circumstance, a seal is accomplished by seating the valve bodies with the valve seats. U.S. Pat. Nos. 6,260,569 and 6,546,947 disclose additional improvements in such a safety fluid conduit system. These patents disclose a system that operates when there is a drive away hose failure where the hose ruptures or there is a full separation of the plates of a four shear bolt breakaway coupling where all of the shear bolts break away. However, the fluid conduit system may not immediately operate to stop the flow of fluid through the hose when there is a partial coupling separation such as where all of the shear bolts do not break and the plates of the four bolt breakaway coupling remain held together by the remaining shear bolts.

What is needed is a new improved fluid conduit safety system that can be used together with a new improved breakaway coupling where fluid flow through a flexible conduit is immediately stopped in both directions in the event that there is a hose failure due to a drive away, a coupling separation, a hose separation or a longitudinal tear in the hose.

### SUMMARY OF THE INVENTION

In an embodiment, there is disclosed a flexible fluid conduit having a breakaway coupling at one or both ends and a safety system that includes a spring in compression which applies thrust (a push) to flapper valves at both ends of the flexible fluid conduit through relatively stiff bendable spring rods which push the valves open as long as the flexible hose is intact. Upon a hose failure such as a drive away, a coupling separation, a hose separation, or a longitudinal tear, the spring looses its compression and the pull that was applied to the valves by the spring in compression changes to a pull which immediately pulls the valves closed. The compression spring can work where the hose elongates since the spring coil can be designed to address this elongation. The spring coil can be made so that when it expands from its compressed state to its naturally coiled uncompressed position it can expand by an amount equal to the hoses elongation thereby permitting elongation.

The breakaway coupling that is used with the flexible fluid conduit is readily applied to a new flexible conduit or to retrofitting an existing flexible conduit. The breakaway coupling has two generally triangular flanges of a metal such as stainless steel, steel, iron, brass, bronze, or the like, where each flange has a central opening surrounded by a sealing O ring and openings located at each corner of the triangle for receiving three shear bolts.

To assemble, the breakaway coupling, an O ring is placed around central opening in one of the triangular flanges, and the two triangular flanges are positioned opposite to each other with the openings at the corners of the two triangular flanges aligned with each other. Shear bolts are inserted into the aligned three openings, nuts are threaded onto the ends of the three shear bolts and each shear bolt is tightened to have the same foot/lbs value. The breakaway coupling can be located at one or both ends of the flexible fluid conduit.

In the safety system disclosed, first and second housings are attached to the first and second ends of the flexible fluid conduit and a first flapper type valve is located in the first housing and a second flapper type valve is located in the second housing, where the first and second flapper type valves are located at a first predetermined distance from each other.

The spring in the conduit is in a compressed state. One end of the compressed spring is connected via a relatively stiff spring rod to the flapper type valve at one end of the flexible conduit, and the other end of the spring is connected via a second relatively stiff spring rod to the flapper type valve at the other end of the flexible conduit. The push force, the thrust, of the compressed spring, acting through the relatively stiff spring rods keeps the two flapper type valves open by pushing on the valves with substantially equal force. This thrust is applied to the valves only while the spring is compressed. and while the flexible conduit is intact.

In the event of a hose failure where the spacing between the two flapper type valves increases or the spring rod on either side of the compressed spring protrudes through a longitudinal tear in the flexible hose, the compressed spring will expand to its relaxed state and, instead of applying a thrust to the valves at the ends of the conduit, will now pull the valves to their closed condition.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings wherein similar reference numeral represent similar parts throughout the various views of the drawings.

FIG. 1 is a cut away view of a flexible fluid conduit safety system that has a spring in compression located in the conduit which applies thrust through relatively stiff bendable spring rods to urge flapper type valves at each end of the conduit to stay open to allow full fluid flow. Upon the occurrence of a conduit failure, the increase in the length of the conduit is greater than the increase in the length of the spring which converts the push on the valves to a pull on the valves, and the flapper type valves are pulled closed to prevent fluid flow through the conduit in accordance with the principles of the invention;

FIG. 2 is a cut away view of a fluid conduit safety system showing a drive away hose failure with the valves closed and flow shut off in accordance with the principles of the invention;

FIG. 3 is a cut away view of a fluid conduit safety system showing a breakable coupling separation with the valves closed and flow shut off in accordance with the principles of the invention;

FIG. 4 is a cut away view of a fluid conduit safety system showing a hose separation with the valves closed and flow shut off in accordance with the principles of the invention;

FIG. 5 is a cut away view of a fluid conduit safety system showing a longitudinal tear with the valves closed and flow shut off in accordance with the principles of the invention;

FIG. 6 is a diagram of a fluid/gas transport vehicle delivering or receiving a fluid to or from a source/destination through flexible fluid conduit coupled to a three bolt breakaway coupler in accordance with the principles of the invention;

FIG. 7 is a side view of a three bolt triangular flange breakaway coupler located between to a valve housing and a tubular member adapted to be attached to a flexible fluid conduit in accordance with the principles of the invention;

FIG. 8 is a view along the line 8-8 of FIG. 7 looking at the interior side of a three bolt triangular flange breakaway coupler in accordance with the principles of the invention;

FIG. 9 is a bottom view of the three bolt triangular flange breakaway coupler of FIG. 7 in accordance with the principles of the invention; and

FIG. 10 is an isometric view of the three bolt triangular flange breakaway coupler of FIG. 7 in accordance with the principles of the invention.

### DESCRIPTION OF THE PREFERRED EMBODIMENT

The flexible fluid conduit safety system has a spring in compression located in the conduit which applies thrust through relatively stiff bendable spring rods to urge flapper type valves at each end of the conduit to stay open to allows full fluid flow. Upon the occurrence of a conduit failure, the increase in the length of the conduit is greater than the increase in the length of the spring, and the push on the valves is changed to a pull on the valves which pulls the flapper type valves closed to prevent fluid flow through the conduit.

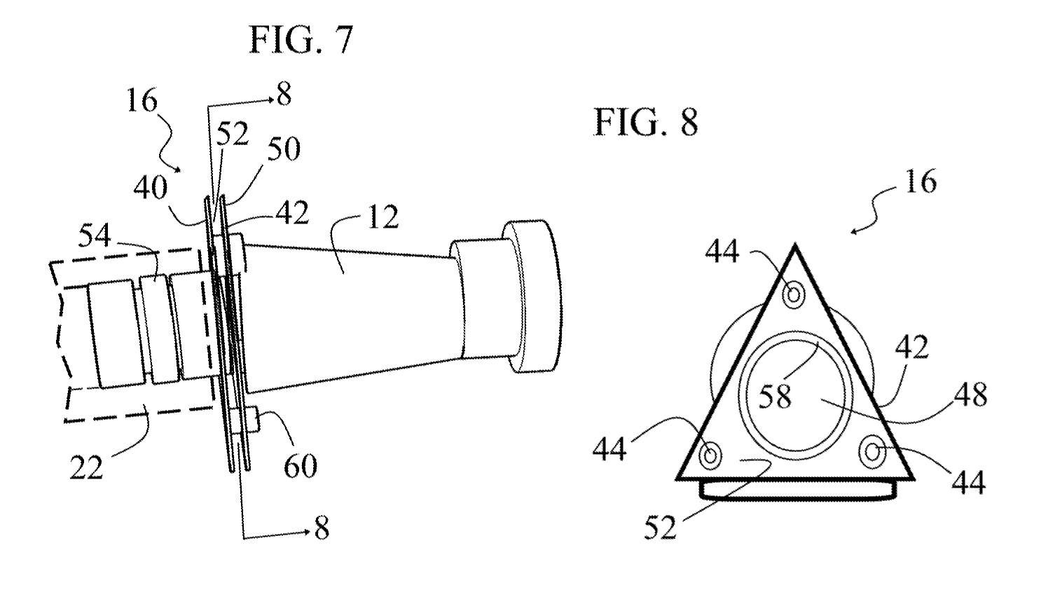

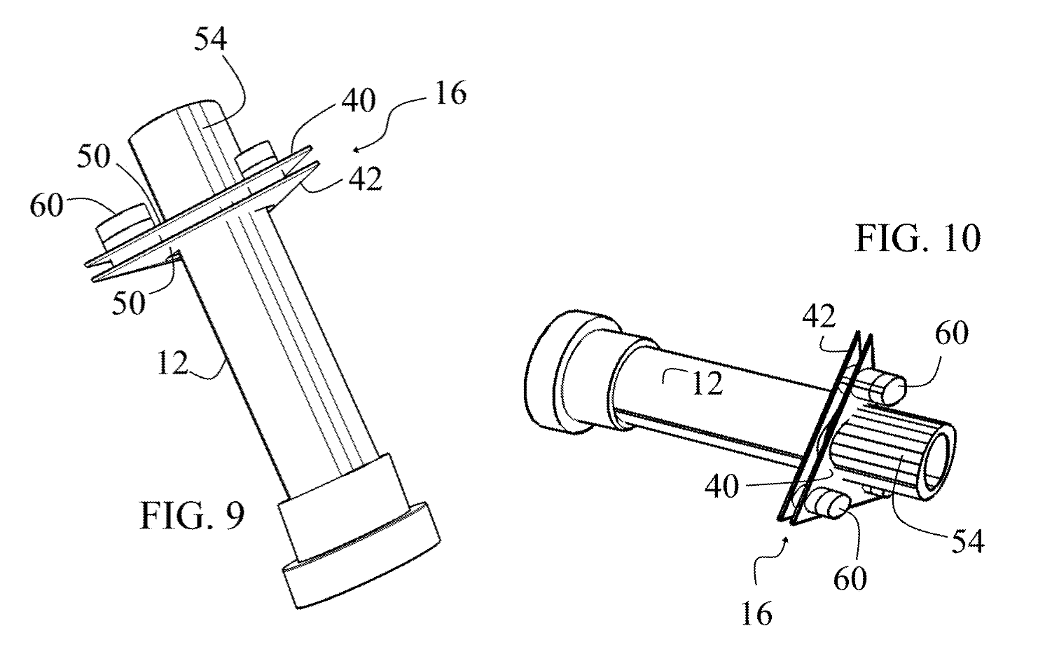

Referring to FIGS. 7-10, the breakaway coupling consists of two substantially similar triangular flanges composed of steel, iron, bronze or any other suitable material. Each triangular shape flange has three openings, an opening at each corner of the triangular flange for receiving three breakaway bolts. The openings can have a circular shape, or they can have a U shape opening or an L shaped opening. The preferred opening is a circular opening.

In an embodiment, the openings in each of the two flanges can be clearance openings for receiving a threaded shear bolt.

In another embodiment, the openings in one of the flanges can be clearance openings for a threaded shear bolt and the openings in the mating flange can be threaded for receiving the threads of shear bolts.

In another embodiment the openings in one of the flanges can be clearance openings for receiving a threaded shear bolt and the openings in the mating flange can hold shear bolts that are press fit into the openings.

Each flange has a centrally located opening that provides a path for a fluid such as a gas or a liquid to pass through. The openings at the three corners of the two triangle shaped flanges for the shear bolts are positioned uniformly around the central opening and are separated from each other by 120 degrees.

Each flange has an exterior side and an interior side where the interior sides of the flanges face each other when the breakaway coupling is assembled. The exterior side of one flange is connected to a longitudinally extending tubular member aligned with the centrally located opening and supports on its outer surface a plurality of ridges which are provided for clamping a flexible fluid conduit to the tubular member in a leak proof manner. The exterior side of the other flange is connected to a flapper type valve housing.

The two mating triangular flanges of the three shear bolt breakaway coupling device will fully separate when subjected to a breaking force at any angle because each of the three shear bolts will break.

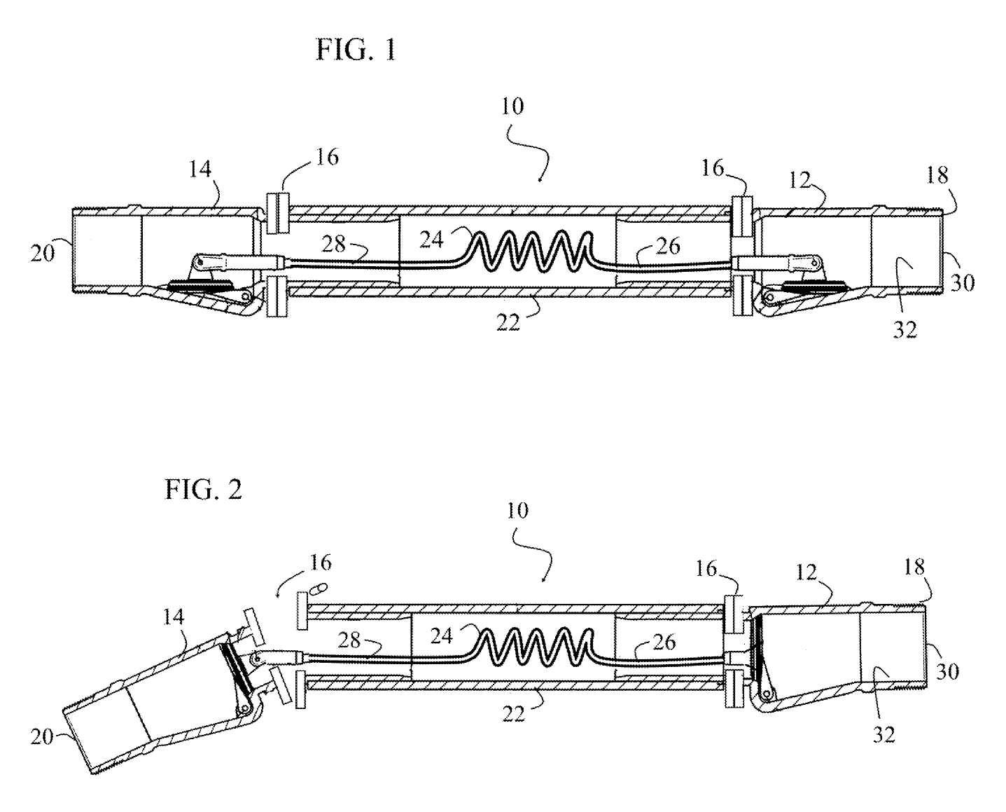

Referring to FIG. 1, there is shown a flexible fluid conduit safety system 10 having a flapper type valve housing 12, 14 at each end which can be coupled to a three bolt breakaway coupling 16 at one or both ends. The fluid conduit safety system 10 comprises a pair of connector ends 18, 20, a flexible fluid conduit or hose 22 disposed between and attached to the respective connectors and an internal compressed spring 24 connected to push the flapper valves to their open state via relative stiff bendable connecting spring rods 26, 28 to allow a fluid to flow through connector ends 18, 20 and hose 22 without leakage.

Connector ends 18, 20 are identical in design, except that they are positioned at opposite ends of hose 22. Accordingly, fluids will flow from one connector end to the other, depending upon whether a container is being filled or being emptied

Connector ends 18, 20, when attached to their respective ends of hose 22 are positioned a predetermined distance from each other which is determined by the length of hose 22.

Connector end 18 includes a flapper type valve housing 12 and means for connection to a valve, container, manifold or other connection to receive or discharge a fluid. Connector end 18 has two openings. In an exemplary embodiment, housing 12 is connected to a three bolt breakaway coupler 16 and is made of a metal such as brass or steel. Other materials can be used that can withstand the pressure and chemical environment. A first opening 30 allows fluids to enter or leave connector end 18 and flexible fluid conduit safety system 10. Housing 12 is substantially hollow, containing a center cavity 32 through which fluids may pass between housings 12 and 14.

In an exemplary embodiment, valve bodies 12, 14 are made of a metal such as brass or steel, or a plastic or composite material. Other materials can be used that can withstand the pressure and chemical environment. The flapper type valves in valve bodies 12, 14 are maintained in their open position by a substantially equal thrust applied to each flapper type valve by a spring 24 in compression applying a thrust through relatively stiff bendable spring rods 26, 28. Spring rods 26, 28 are made of a material that transmits a thrust that pushes the valves to their open position to allow fluid flow.

During normal operation, hose 22 has a specific length and the overall length of compressed spring 24 and spring rods 26, 28 is fixed to apply a thrust to the flapper type valves that are at a fixed distance from each other. At any instant that the hose experiences a failure, its length will increase and the space between the valve bodies will increase in length by a distance that is greater than the increase in length of the spring as it looses it's compression. Thus, when a hose fails, the distance between the valve housings increase by a distance that is greater than the increase in the length of the spring and the thrust that was applied to the flapper type valves now becomes a pull which is used to close the valves. Therefore, at the instant that a hose fails the valves are pulled close and the flow of a fluid through the hose is stopped.

A failure of hose 22 which causes the spring in the hose to lose compression will cause the valves at each end of the hose to close. The compression spring can work where the hose elongates since the spring coil can be designed to address this elongation. The spring coil can be made so that when it expands from its compressed state to its naturally coiled uncompressed position it can expand by an amount equal to the hoses elongation thereby permitting elongation.

Referring to FIG. 2, there is shown a cut away view of a flexible fluid conduit safety system showing a drive away hose failure where the three bolt breakaway coupler 16 separates and the valves close to shut off all flow. When the drive away hose failure occurred, the three bolt breakaway coupling separated which allowed valve housings to move apart. This increase in valve separation allowed spring 24 to loose its compression and convert the push that was applied to the valves to a pull which pulls the valves to their closed position. Stated differently, a hose failure changes the thrust that is applied to the valves to a pull which closes the valves.

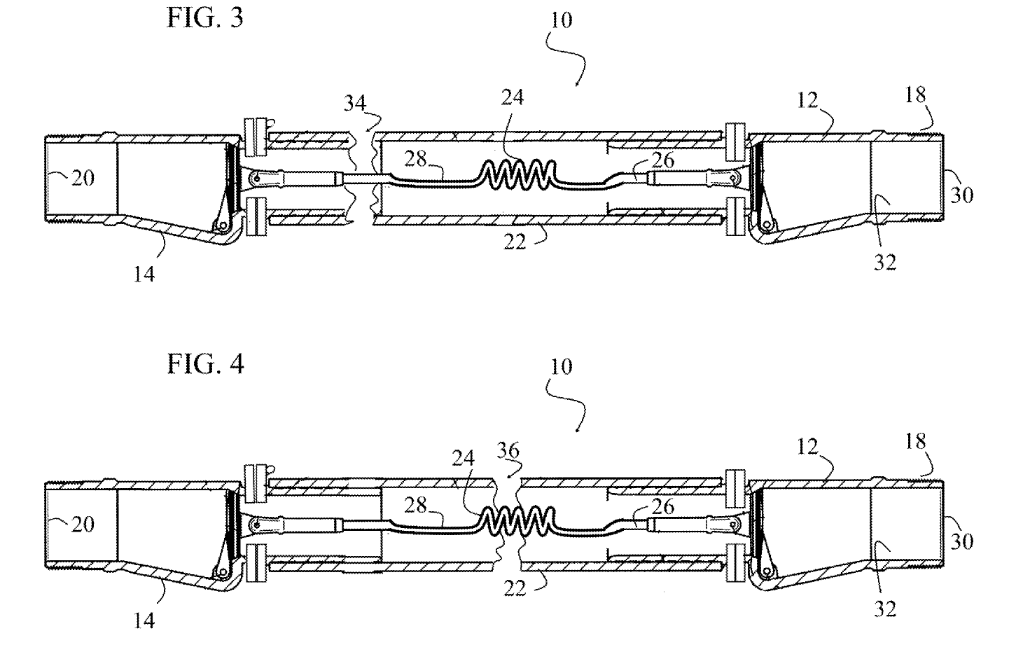

Referring to FIG. 3, there is shown a cut away view of a fluid conduit safety system showing a coupling separation 34. When the coupling separation occurred, the spacing between the valve bodies increased, spring 24 expanded to its uncompressed state, and the thrust that was applied to the valves changed to a pull which operated to immediately close the valves.

Referring to FIG. 4, there is shown a cut away view of a hose separation 36. When the hose separation occurred, the spacing between the valve bodies increased, spring 24 expanded to its uncompressed state, and the thrust that was applied to the valves changed to a pull which operated to immediately close the valves.

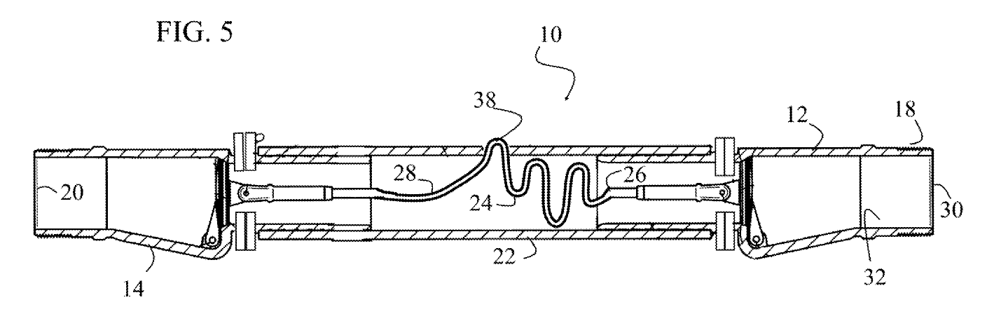

FIG. 5 is a cut away view of a fluid conduit safety system showing a longitudinal tear 38 and the thrust that was applied to the valves changed to a pull which operated to immediately close the valves.

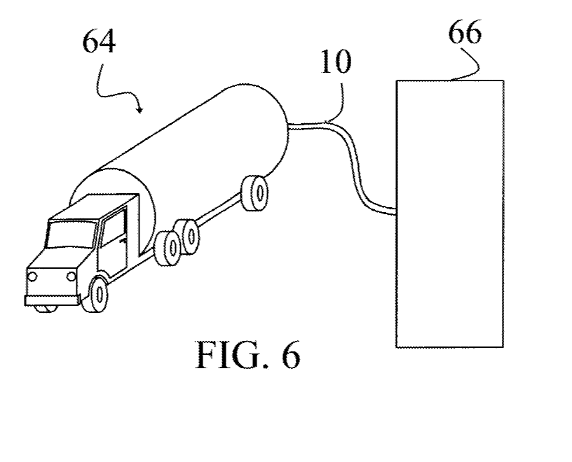

FIG. 6 shows a fluid transport vehicle 64 connected to a source/destination container 66 through fluid conduit safety system 10. Transport vehicle 64 can be delivering or receiving fluid, depending upon the particular application.

In operation, a first end of the fluid conduit is connected to a filling container, while the second end of the fluid conduit is connected to a receiving container. The exact nature of the filling container and the receiving container depends upon the ultimate application. For example, the filling container may be a transport vehicle or connected through a hose or routing system before the connection is made to the fluid conduit of the present invention. A similar situation may apply to the receiving container.

Referring to FIGS. 7, 8, 9, and 10, there is shown a three bolt breakaway coupling 16 for use with the flexible fluid conduit. The three bolt breakaway coupler 16 consists of a first flange 40 and a second flange 42 each of which has a shape that is triangular and can be composed of steel , iron, bronze, brass or any other suitable metal. In the embodiment shown in FIGS. 7-10, each flange has a triangular shape and each flange has three openings 44 for receiving breakaway bolts 60. In an embodiment, the openings in the first flange are clearance openings for a threaded shear bolt and the openings in the second flange are threaded for receiving the threads of shear bolts. Each flange has a centrally located opening 48 that provides a path for a fluid such as a gas or a liquid to pass through. The openings in the triangular flanges for the shear bolts are positioned uniformly around the central opening 48 and are separated from each other by 120 degrees.

Each flange has an exterior side 50 and an interior side 52 where the interior sides of the flanges face each other when the three bolt breakaway coupling is assembled. The exterior side of flange 40 is connected to a longitudinally extending tubular member 54 that is aligned with the centrally located opening 48 and supports on its outer surface a plurality of ridges which are provided for clamping flexible hose which is the fluid conduit of FIG. 1 to the tubular member in a leak proof manner.

The interior side of each flange supports a groove 58 located around the centrally located opening for receiving an O ring. When the two flanges are bolted together, the O ring provides a leak proof seal. The exterior side of the second flange 42 is attached to the valve housing 12 (see FIG. 1) of the flapper type valve.

To assemble the three bolt breakaway coupling, an 0 ring is positioned in the groove 58 in one of the flanges and the interior sides of the two flanges are positioned opposite each other with the openings 44 of the two flanges in alignment. The threaded ends of breakaway bolts (shear bolts) 60 are then inserted into clearance openings in the first flange and threaded into the threaded openings in the second flange. The breakaway bolts can have hexagonal heads and are made of stainless steel. It is understood that a material other than stainless steel can be used for the shear bolts. The three shear bolts are tightened to torque each shear bolt to the same ft/lbs.

The three bolt breakaway coupling, when subjected to a predetermined breaking force at any angle, will break at least two of the three shear bolts. Thus, the shear bolts will break when a breaking force is applied to the three bolt breakaway coupling here disclosed.

Shear bolts that are of various sizes and/or material can be used to meet specific pressure and load requirements. The three bolt breakaway coupling has three shear bolts. Because all of the shear bolts will break at the same time, increased safety and protection is provided against an unintended pull away of tank trucks, railcars, barges and ships.

In an exemplary embodiment of the flexible fluid conduit safety system where flapper valves are held open by a push force supplied by a spring in compression connected to the flapper valves via spring rods in combination with at least one three bolt breakaway coupling, a hose failure will immediately cause the push force that is being applied to keep the valves open to become a pull force to cause the flapper valves to close shutting off all fluid flow.

Fluid/gas conduit safety system 200 is shown with internal spring rods 26, 28 located between the spring in compression and the normally closed flapper valves. Internal spring rods 26, 28 have sufficient stiffness to transmit the thrust from the compressed spring to the valves to push and keep each valve in its open state. Upon a failure condition of the hose, spring 24 expands and is no longer in compression, and no longer applies thrust to the valves through the spring rods to keep the valves open. A loss of spring force can occur from a hose failure such as a coupling separation, a hose separation, a longitudinal tear, or a drive away.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A safety system for a fluid conduit comprising:
a flexible fluid conduit having first and second ends;
first housing having a first end coupled to said first end of said flexible fluid conduit;
second housing having a first end coupled to said second end of said flexible fluid conduit, a first valve located in said first housing;
a second valve located in said second housing;
a spring having first and second ends located in said flexible fluid conduit;
a first spring rod having a first end coupled to said first end of said spring and a second end coupled to said first valve; and
a second spring rod having a first end coupled to said second end of said spring and a second end coupled to said second valve;
wherein said spring, when in compression, pushes on said first and second spring rods to urge said first and second valves to their open condition and, upon the occurrence of a failure in the flexible fluid hose, said spring pulls on said first and second valves to close said valves.

2. The safety system of claim 1 wherein said spring is in compression.

3. The safety system of claim 2 wherein the distance between said first and second valves in said first and second housings is set to a distance that keeps said spring in its compressed state.

4. The safety system of claim 3 wherein said first and second spring rods are relatively stiff bendable spring rods.

5. The safety system of claim 4 wherein said first and second valves are flapper type valves.

6. The safety system of claim 5 wherein said compressed spring acting through the first and second relatively stiff first and second spring rods pushes said valves to their open position.

7. The safety system of claim 6 wherein the push applied to the first and second valves by said compressed spring acting through said first and second spring rods converts to a pull to close said first and second valves upon a failure of the flexible fluid conduit.

8. The safety system of claim 7 wherein said failure is a drive away type of failure.

9. The safety system of claim 7 wherein said failure is a coupling separation type of failure.

10. The safety system of claim 7 wherein said failure is a flexible fluid conduit failure.

11. The safety system of claim 7 wherein said failure is a flexible fluid conduit coupling failure.

12. The safety system of claim 1 further comprising a three bolt breakaway coupling connected to a second end of said first housing;
wherein at least two of the three shear bolts of the three bolt breakaway coupling break when said breakaway coupling is subjected to an impact or a pull of sufficient force which causes the first and second valves to close to stop the flow of fluid through the conduit.

13. The safety system of claim 12 wherein said .three bolt breakaway coupling has a generally triangular shaped first flange having an exterior and interior side and a centrally located fluid passageway;
said triangular shaped first flange having an openings at each of the three corners;
a generally triangular shaped second flange having an exterior and interior side and a centrally located fluid passageway;
said triangular shaped second flange having an openings at each of the three corners;
a threaded shear bolt located in each of the three openings for drawing said first and second flanges together forming a leakproof connection between the interior sides of the two flanges; and
means for attaching said exterior sides of the three bolt breakaway coupling to said first housing between the first valve and the second end of the housing.

14. The safety system of claim 13 wherein said openings in said triangular flanges are holes.

15. The safety system of claim 13 wherein said openings in one of said triangular flanges are U shaped notches.

16. The safety system of claim 13 wherein said openings in one of said triangular flanges are L shaped notches
